(19) United States
(12) Patent Application Publication
(10) Pub. No.: US 2003/0202446 A1
(43) Pub. Date: Oct. 30, 2003

(54) Lead wiring structure and disk device

(76) Inventors: Kiyofumi Sato, Kanagawa (JP); Satoru Manabe, Kanagawa (JP); Tsuneo Uwabo, Kanagawa (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/421,708

(22) Filed: Apr. 24, 2003

(30) Foreign Application Priority Data
Apr. 26, 2002 (JP) P2002-126135

(51) Int. Cl. G11B 33/02; G11B 5/012; G11B 17/00

(52) U.S. Cl. 369/75.1; 360/97.01

(57) ABSTRACT

A lead wiring structure, includes a wall portion, having a first face and a second face, and having a first penetrating portion which penetrate from the first face to the second face and through which a lead is passed. The first penetrating portion has a third face and a fourth face which are opposite to each other via a pass of the lead. The first face forms an acute angle with the third face, and the second face forms an acute angle with the fourth face.

### BACKGROUND OF THE INVENTION

The present invention relates to a lead wiring structure, and to a disk device in used of the lead wiring structure.

A disk device for reproducing (or for recording/reproducing) information recorded on a compact disk or the like is known. This device has a box-like (or frame-like) chassis, which constitutes the frame of a device body, and also has a disk tray, which is movably provided in the chassis, and a mechanism unit provided with a turntable, on which a disk is put, and with an optical pickup for reproducing (or for recording and reproducing) data recorded on the disk.

Further, the chassis is equipped with a drive mechanism, which has a motor for driving the disk tray, and with a printed circuit board (that is, a main circuit board), on which an interface connector and various kinds of electronic parts are mounted.

Such a motor and the printed circuit board are installed apart from each other in the chassis from the viewpoint of configuration of the disk device. These elements are electrically connected by motor leads.

Further, halfway parts of such motor leads are fixed to the chassis. Recently, the each of such motor leads is fixed by placing the motor lead in a groove (that is, a concave portion) formed in the chassis and then fitting (or stuffing) a fixing member, such as a sponge, into the groove during such a stage.

However, such a fixing method has problems in that the number of components increases, and that secure fixation of the motor leads cannot be achieved.

### SUMMARY OF THE INVENTION

It is therefore an object of the present invention to provide a lead wiring structure, which has a simple configuration and is enabled to securely fix leads to a wall portion, and to provide a disk device to which such a lead wiring structure is applied.

To achieve such objects, the invention provides the following items (1) to (21).

(1) A lead wiring structure for wiring leads so that leads each connected to a terminal at least at one end portion thereof are drawn out from the side of one of faces of a wall portion to the side of the other face thereof through a penetrating portion formed in such a way as to penetrate through the wall portion. In this structure, the penetrating portion has a pair of faces opposed through a path through which the lead passes. Between the pair of faces, the face provided at the side of the one end portion of the lead forms an acute angle with the one of faces. The face opposite to the face provided at the side of the one end portion forms with an acute angle with the other of the faces.

(2) A lead wiring structure according to the item (1), in which each of the acute angles ranges from 35° to 55°.

(3) A lead wiring structure according to the items (1) or (2), in which the penetrating portion is constituted by a slit.

(4) A lead wiring structure according to the items (3), in which one of ends of the slit is a closed end, while the other end thereof is an open end opened to an edge part of the wall portion.

(5) A lead wiring structure according to the items (4), in which the wall portion has a guide portion for guiding insertion of the lead into the slit.

(6) A lead wiring structure according to the item (5), in which the width of the slit gradually increases in a direction toward the open end thereof in the guide portion.

(7) A lead wiring structure according to the item (5), in which the guide portion is formed by deleting a part of the wall portion, and in which the part is located in the vicinity of the open end.

(8) A lead wiring structure for wiring leads so that leads each connected to a terminal at least at one end portion thereof are drawn out from the side of one of faces of a wall portion to the side of the other face thereof through a first penetrating portion formed in such a way as to penetrate through the wall portion, and that the leads drawn out to the side of the other face are drawn back to the side of the one of faces of the wall portion through a second penetrating portion formed in such a manner as to penetrate through the wall portion. In this structure, at least one of the first penetrating portion and the second penetrating portion is constituted by the penetrating portion of one of the items (1) to (7).

(9) A lead wiring structure for wiring leads so that leads each connected to a terminal at least at one end portion thereof are drawn out from the side of one of faces of a wall portion to the side of the other face thereof through a first penetrating portion formed in such a way as to penetrate through the wall portion, and that the leads drawn out to the side of the other face are drawn back to the side of the one of faces of the wall portion through a second penetrating portion formed in such a manner as to penetrate through the wall portion. In this structure, at least of the first penetrating portion and the second penetrating portion is constituted by the slit of one of the items (4) to (7).

(10) A lead wiring structure according to the item (9), in which the wall portion has a retaining portion for causing the leads to engage with the other face so as to prevent the leads from being released from the slit.

(11) A lead wiring structure according to the item (10), in which the retaining portion is erected from the other face of the wall portion and shaped by being bent or curved in such a way as to halfway become nearly parallel to the wall portion.

(12) A lead wiring structure according to the items (8) to (11), in which a spaced distance between the first penetrating portion and the second penetrating portion increases in a direction from the one of faces to the other face.

(13) A lead wiring structure for wiring leads so that leads each connected to a terminal at least at one end portion thereof are drawn out from the side of one of faces of a wall portion to the side of the other face thereof through a first penetrating portion formed in such a way as to penetrate through the wall portion, and that the leads drawn out to the side of the other face are drawn back to the side of the one of faces of the wall portion through a second penetrating portion formed in such a manner as to penetrate through the wall portion. In this structure, at least one of the first penetrating portion and the second penetrating portion is constituted by a slit. The wall portion is erected from the other face, and shaped by being bent or curved in such a way as to halfway become nearly parallel to the wall portion, and has a plurality of retaining portions for retaining the leads so as to prevent the leads from being released from the slit. The retaining portions are placed so that ends of adjacent ones of the retaining portions are directed in nearly opposite directions.

(14) A lead wiring structure according to the item (13), in which one of ends of the slit is a closed end, while the other end thereof is an open end opened to an edge part of the wall portion.

(15) A lead wiring structure according to the items (13) or (14), in which the wall portion has a guide portion for guiding insertion of the lead into the slit.

(16) A lead wiring structure according to the item (15), in which the guide portion is formed by deleting a part of the wall portion, and in which the part is located in vicinity of the open end.

(17) A lead wiring structure according to the items (15) or (16), in which the width of the slit gradually increases in a direction toward the open end thereof in the guide portion.

(18) A lead wiring structure according to the items (13) to (17), in which at least of the first penetrating portion and the second penetrating portion is constituted by the slit of one of the items (4) to (7).

(19) A lead wiring structure according to the items (10) to (18), in which the retaining portion is provided between the first penetrating portion and the second penetrating portion.

(20) A lead wiring structure according to the items (10) to (19),in which the retaining portion is formed in such a manner as to be integral with the wall portion.

(21) A disk device having a motor and a main circuit board. In this disk device, the lead of one of the items (1) to (20) corresponds to a motor lead connecting a terminal of the motor to a predetermined terminal of the main circuit board. The wall portion of one of the items (1) to (20) corresponds to a side wall of the chassis.

As described above, according to the invention, leads can securely be fixed to the wall portion by employing a simple structure.

Consequently, according to the invention, the number of components, the number of steps of a manufacturing process, and the manufacturing cost can be reduced.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a top view of a chassis of a disk device according to a first embodiment of the invention;

FIG. 2 is a bottom view of the chassis shown in FIG. 1;

FIG. 3 is an enlarged view of a part located in the vicinity of a first slit;

FIG. 4 is a side view of the chassis shown in FIG. 1; and

FIG. 5 is a side view of a chassis of a disk device according to a second embodiment of the invention.

### DETAILED DESCRIPTION OF THE PREFERRED EMBODIMENTS

Preferred embodiments of a lead wiring structure and a disk device according to the invention are described in detail with reference to the accompanying drawings.

The lead wiring structure according to the invention can be applied to various device. However, hereunder, a description is given for a typical case of application of the invention to a disk device having a function of reproducing or recording/reproducing information recorded on various disks, such as CD, CD-ROM, CD-R, DVD, DVD-R, DVD-RW, for recording, for instance, music.

(First Embodiment)

First, a disk device, to which a first embodiment of the lead wiring structure according to the invention is applied, that is, a first embodiment of the disk device according to the invention is described hereinbelow.

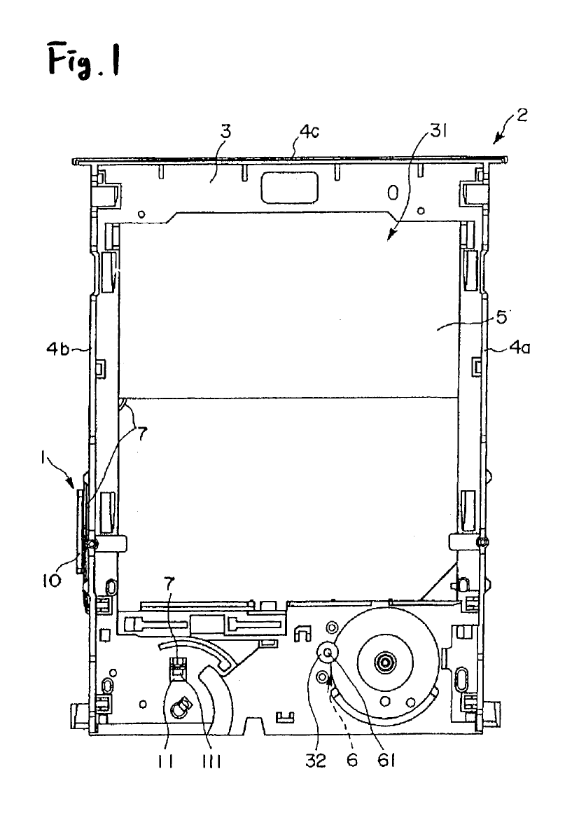

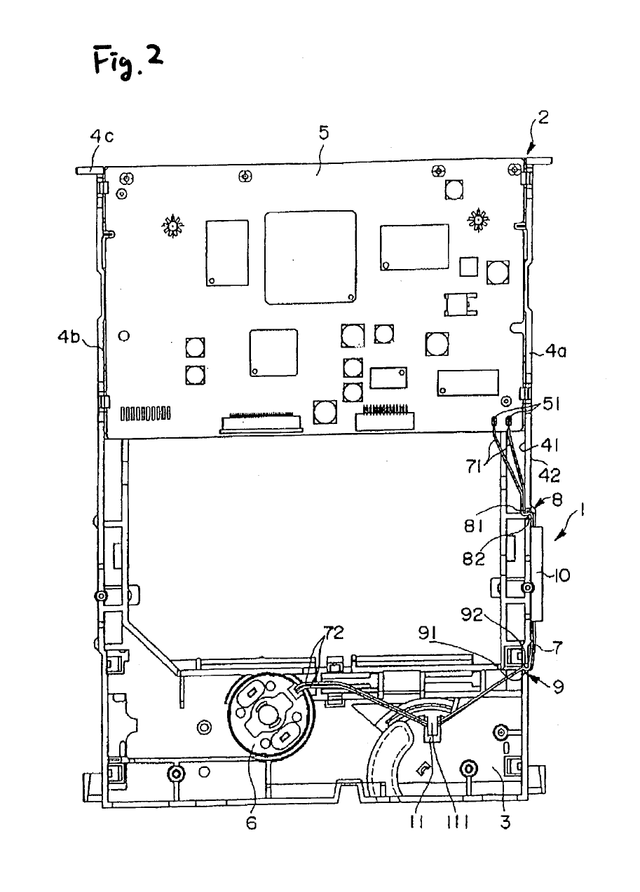

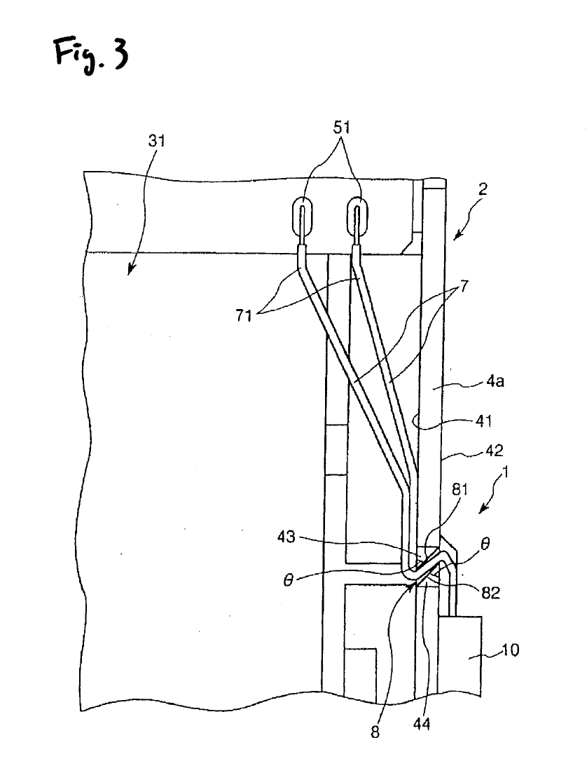

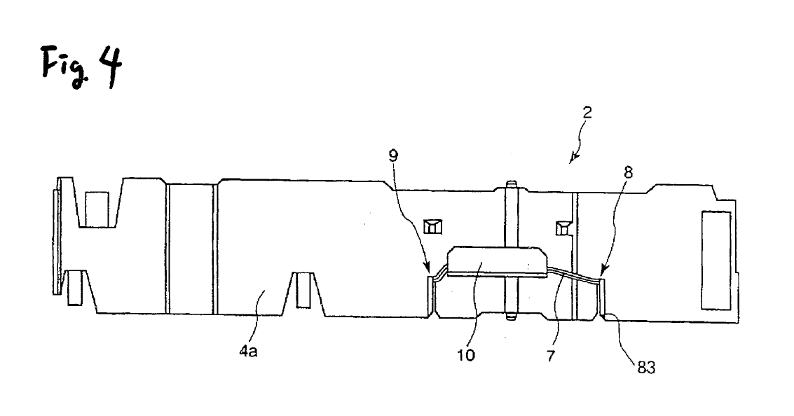

FIG. 1 is a top view of a chassis of the disk device according to the first embodiment of the invention. FIG. 2 is a bottom view of the chassis shown in FIG. 1. FIG. 3 is an enlarged view of a part located in the vicinity of a first slit. FIG. 4 is a side view of the chassis shown in FIG. 1. Incidentally, in the following description, upward, downward, rightward, and leftward directions as viewed in each of FIGS. 1 and 3 are referred to as “rearward”, “frontward”, “rightward”, and “leftward” directions, respectively. Further, upward, downward, rightward, and leftward directions as viewed in FIG. 2 are referred to as “rearward”, “frontward”, “leftward”, and “rightward” directions, respectively. Furthermore, leftward and rightward directions as viewed in FIG. 4 is referred to as “rearward” and “frontward” directions, respectively.

This device has a box-like (or frame-like) chassis 2, which constitutes the frame of a device body, and also has a disk tray (not shown), which is movably provided in this chassis 2, and a mechanism unit (not shown) provided with a turntable, on which a disk is put, and with an optical pickup for reproducing or for recording/reproducing data recorded on the disk.

Further, as shown in FIGS. 1 and 2, the chassis 2 is equipped with a printed circuit board (that is, a main circuit board) 5 and a drive mechanism having a (loading) motor for driving the disk tray.

Interface connector for connection with a computer main unit, various ICs, such as a microprocessor, memories and a motor driver, and various electrical components, such as resistors, capacitors and switches, are mounted on the printed circuit board 5. Further, through these elements, a spindle motor, a loading motor, a sled motor, and an optical pickup are controlled.

The chassis 2 is formed from a (hard) resin material. This chassis 2 has a plate-like bottom portion 3, side walls 4a and 4b erected on left and right edge parts of the bottom portion 3, and a rear wall 4c erected on a rear edge part thereof That is, the side walls 4a and 4b and the rear wall 4c are erected nearly like a letter “U” along the edge parts of the bottom portion 3.

Furthermore, no wall portions are formed in front of the chassis 2, so that the chassis 2 is frontwardly opened. Further, this part is aligned with an opening, from which the disk tray is taken in and out, in a main unit of the device.

In the bottom portion 3 of the chassis 2, an opening 31 shaped nearly like a rectangle is formed. In this opening 31, a (sled) mechanism unit is disposed.

The motor 6 is provided on a rear face of a front portion of the chassis 2. Rotation shaft 61 of the motor 6 upwardly projects from an opening 32 formed in the bottom portion 3 of the chassis 2. Further, the printed circuit board 5 is provided on a back face of a rear portion of the chassis 2.

Further, the motor 6 is electrically connected to the printed circuit board 5 by motor leads 7. That is, both end portions 71 and 72 of each of the motor leads 7 are connected to a predetermined terminal 51 of the printed circuit board 5 and to a terminal (not shown) of the motor 6, respectively.

A partway portion of this motor lead 7 is fixed to the chassis 2 (that is, the side wall 4a). Consequently, the motor leads 7 can surely be prevented from going into the opening 31 of the bottom portion 3. Thus, the motor leads 7 can surely be prevented from interfering with the mechanism unit disposed in the opening 31.

Hereinafter, a method of fixing this motor lead 7 to the side wall 4a, thus, the lead wiring structure 1 according to the invention is described.

As shown in FIG. 2, a first slit (that is, a first penetrating portion) 8 and a second slit (that is, a second penetrating portion) 9 are formed in the side wall (or wall portion) 4a in such a manner as to penetrate through the side wall 4a in the direction of thickness thereof.

Further, each of the motor leads 7 is drawn out from the side of the inner face (that is, one of the faces) 41 of the side wall 4a to the side of the outer face (that is, the other face) 42 through this first slit 8. Then, each of the motor leads 7 drawn out to the side of this outer face 42 is wired by being drawn back to the side of the inner face 41 through a second slit 9.

Incidentally, in this embodiment, the first slit 8 has a structure similar to that of the second slit 9. Therefore, only the first slit 8 is described hereunder as a typical one.

Edge portions 43 and 44 are formed on the side wall 4a so that an end part of these edge portions form an acute angle. The first slit 8 inclined to the side wall 4a by a predetermined angle is formed by the edge portions 43 and 44.

That is, this first slit 8 has a pair of faces 81 and 82 opposed through a path through which the motor leads 7 pass. Between these faces, the face 81 is a face thereof at the side of the end portion (that is, the one of end portions) 71 of each of the motor leads 7, which is connected to the predetermined terminal 51 of the printed circuit board 5. The face 81 is continued to the inner face 41 of the side wall 4a. On the other hand, the face 82 is opposite to the face 81, and continued to the outer face 42 of the side wall 4a. Further, the face 81 forms an acute angle with the inner face 41 of the side wall 4a, while the face 82 forms an acute angle with the outer face 42 of the side wall 4a.

With such configuration, each of the motor leads 7 passing through the first slit 8 is pushed by the edge portions 43 and 44 almost in the opposite directions (that is, in frontward and rearward directions). Thus, the motor leads 7 are disposed in such a way as to be nearly Z-shaped in the vicinity of the first slit 8 (see FIG. 3).

Consequently, when backward tensile stress acts on the motor lead 7 placed on the inner side of the chassis 2, or when frontward tensile stress acts on the motor lead 7 placed on the outer side of the chassis 2, or when both the backward and frontward tensile stresses act thereon, the end parts of the edge portions 43 and 44, on which the stresses are concentrated, are pushed against and bite into the insulating coating layers formed on the outer circumferential portions of the motor leads 7, because the end part of the edge portion 43 forms an acute angle with that of the edge portion 44. This regulates or prevents the movement of the motor leads 7. That is, the motor leads 7 are fixed to the side wall 4a.

The acute angle θ shown in FIG. 3 is not limited to a specific value. However, preferably, the acute angle ranges from 35 to 55 degrees or so. More preferably, the acute angle ranges from 40 to 50 degrees or so. Thus, the motor leads 7 can be more securely fixed to the side wall 4a while the strength of the side wall 4a is maintained.

Such a first slit 8 has ends, one of which is a closed end, and the other of which is an open end opened to the lower edge portion of the side wall 4a.

Further, as shown in FIG. 4, the side wall 4a has a guide portion 83 for guiding the insertion of the motor leads 7 into the first slit 8. Furthermore, the width of the first slit 8 gradually increases in the direction of the open end in this guide portion 83. This guide portion 83 is formed by deleting parts located in the vicinity of the open end of the first slit 8 in the side wall 4a, that is, the bottom parts of the edge portions 43 and 44. The provision of the guide portion 83 of such a configuration enables smoother insertion of the motor leads 7 into the first slit 8.

The second slit 9 has a structure similar to that of the first slit 8. The second slit 9 has a pair of faces 91 and 92 opposed through a path through which the motor leads 7 pass. Between these faces, the face 91 is a face thereof at the side of the end portion (that is, the one of end portions) 72 of each of the motor leads 7, which is connected to the terminal of the motor 6. The face 91 is continued to the inner face 41 of the side wall 4a. On the other hand, the face 92 is opposite to the face 91, and continued to the outer face 42 of the side wall 4a. Further, the face 91 forms an acute angle with the inner face 41 of the side wall 4a, while the face 92 forms an acute angle with the outer face 42 of the side wall 4a. That is, the face 91 corresponds to the face 81, while the face 92 corresponds to the face 82.

Therefore, when the chassis 2 is viewed from the bottom face side, the direction of inclination of the first slit 8 to the side wall 4a is opposite to that of inclination of the second slit 9 thereto. The spaced distance therebetween increases in the direction from the inner face 41 of the side wall 4a to the outer face 42 thereof.

Such configuration, that is, the formation of the first slit 8 and the second slit 9 into similar structures enables more secure fixation of the motor leads 7 to the side wall 4a.

Moreover, the side wall 4a has a retaining portion 10 for retaining the motor leads 7 so as to prevent the motor leads 7 from being released from the first slit 8 and the second slit 9. This retaining portion 10 is erected from the outer face 42 of the side wall 4a, and shaped by being bent or curved in such a way as to halfway become nearly parallel to the side wall 4a. The provision of such a retaining portion 10 can surely prevent the motor leads 7 from being released from the first slit 8 and the second slit 9.

This retaining portion 10 is provided between the first slit 8 and the second slit 9. Consequently, the motor leads 7 can be prevented from being unnecessarily elongated.

Preferably, such a retaining portion 10 is formed in such a manner as to be integral with the side wall 4a (thus, the chassis 2). Consequently, the number of components can be reduced.

The lead wiring structure 1 of the invention is constituted by the first slit 8, the second slit 9, and the retaining portion 10. According to such a lead wiring structure 1, the motor leads 7 can securely be fixed to the side wall 4a by employing a simple configuration. Thus, the number components, the number of steps of a manufacturing process, and the manufacturing cost can be reduced.

Furthermore, in this embodiment, a nearly U-shaped slit 11 is formed approximately at an intermediate position between the side wall 4a and the motor 6 in the bottom portion 3 of the chassis 2. In a portion surrounded by this slit 11, a claw portion 111 is formed in such a way as to be integral with the bottom portion 3. This claw portion 111 is cantilever-supported on the bottom portion 3 by employing an end thereof as a moving end, and also employing a base end as a stationary end thereof. The motor lead 7 positioned between the second slit 9 and the motor 6 is fixed to the bottom portion 3 by being caught by the claw portion 111.

Incidentally, only one of the first slit 8 and the second slit 9 may be a slit of the configuration. In this case, the other slit may be provided in such a way as to be nearly parallel to the direction of thickness of the side wall 4a. Alternatively, the other slit may have ends, both of which are open ends.

Further, according to the invention, one or each of the first penetrating portion and the second penetrating portion may be constituted by a through hole instead of the slit. The constitution is applied to this through hole, that is, the constitution, in which the through hole is inclined to the wall portion by a predetermined angle, is applied thereto.

(Second Embodiment)

Next, a disk device to which a second embodiment of the lead wiring structure according to the invention is applied, that is, a second embodiment of the disk device according to the invention is described hereinbelow.

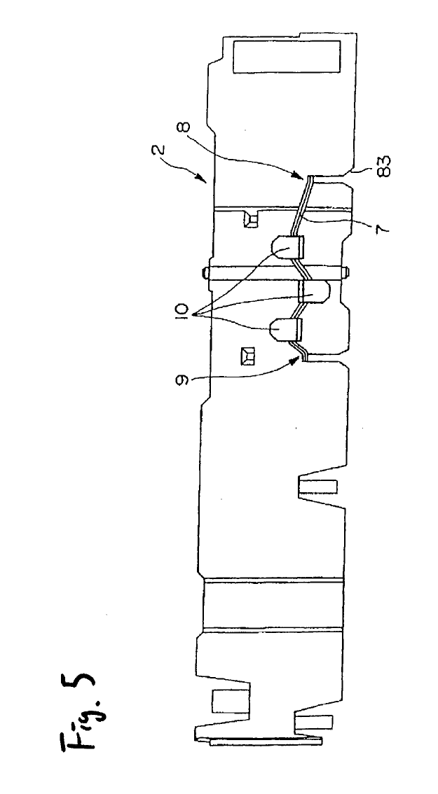

FIG. 5 is a side view of a chassis of the second embodiment of the disk device according to the invention. Incidentally, in the following description, the left side as viewed in FIG. 5 is referred to as a “rearward” side, while the right side as viewed in this figure is referred to as a “frontward” side.

The following description is concentrated on the differences between the first and second embodiments. Description of similarities therebetween is omitted herein.

The second embodiment differs from the first embodiment in the configuration of each of the slits 8 and 9 and the retaining portion 10. The rest of the second embodiment is similar to the corresponding part of the first embodiment.

That is, each of the first slit 8 and the second slit 9 is provided in such a way as to be parallel to the direction of width of the side wall 4a.

Moreover, the retaining portion 10 of the second embodiment is almost similar in the shape of a longitudinal section thereof to the retaining portion 10 of the first embodiment. However, the length in a frontward-rearward direction of the former retaining portion 10 is shorter than that in such a direction of the latter retaining portion 10. Furthermore, the second embodiment is provided with a plurality of such retaining portions 10, which are disposed so that the ends of each pair of adjacent ones of the retaining portions are directed in nearly opposite directions.

With such configuration, the motor leads 7 respectively passing through the retaining portion 10 are pushed by the plurality of retaining portions 10 in nearly opposite directions (that is, in a nearly upward-downward direction). The motor leads 7 are disposed in a wave-like manner (see FIG. 5). Consequently, the motor leads 7 are fixed to the side wall 4a.

Such a second embodiment obtains advantages similar to those of the first embodiment.

Incidentally, one or each of the first slit 8 and the second slit 9 of the second embodiment may have constitution similar to that of each of the slits 8 and 9 of the first embodiment. Consequently, the motor leads 7 can be more securely fixed to the side wall 4a.

Although the lead wiring structure and the disk device embodying the invention have been described above, the invention is not limited thereto. For example, each of constituent portions of the lead wiring structure and the disk device according to the invention may be replaced with any element having similar functions. Alternatively, other constituent elements having similar functions may be added thereto.

Further, for instance, any two or more constituent elements of the first and second embodiments according to the invention may be combined with one another.

Additionally, needless to say, the disk device according to the invention may be applied not only to an optical disk device, such as CD device and DVD device, but to other kinds of optical disk devices or magnetic disk devices.

What is claimed is:

1. A lead wiring structure, comprising:
a wall portion, having a first face and a second face, and having a first penetrating portion which penetrate from the first face to the second face and through which a lead is passed,
wherein the first penetrating portion has a third face and a fourth face which are opposite to each other via a pass of the lead;
wherein the first face forms an acute angle with the third face; and
wherein the second face forms an acute angle with the fourth face.

2. The lead wiring structure as set forth in claim 1, wherein each of the acute angles ranges from 35 to 55 degrees.

3. The lead wiring structure as set forth in claim 1, wherein the first penetrating portion is formed by a slit.

4. The lead wiring structure as set forth in claim 3, wherein one of ends of the slit is a closed end, while the other end thereof is an open end opened to an edge part of the wall portion.

5. The lead wiring structure as set forth in claim 4, wherein the wall portion has a guide portion for guiding insertion of the lead into the slit.

6. The lead wiring structure as set forth in claim 5, wherein width of the slit gradually increases in a direction toward the open end thereof in the guide portion.

7. The lead wiring structure as set forth in claim 5, wherein the guide portion is formed by deleting a part of the wall portion, and the part being located in vicinity of the open end.

8. The lead wiring structure as set forth in claim 1, wherein the wall portion has a second penetrating portion, which penetrate from the first face to the second face and through which the lead is passed; and
wherein the lead is drawn out from the first face to the second face through the first penetrating portion, and is drown back from the second face to the first face through the second penetrating portion.

9. The lead wiring structure as set forth in claim 8, wherein each of the acute angles ranges from 35 to 55 degrees.

10. The lead wiring structure as set forth in claim 8, wherein the second penetrating portion is formed by a slit.

11. The lead wiring structure as set forth in claim 10, wherein one of ends of the slit is a closed end, while the other end thereof is an open end opened to an edge part of the wall portion.

12. The lead wiring structure as set forth in claim 11, wherein the wall portion has a guide portion for guiding insertion of the lead into the slit of the second penetrating portion.

13. The lead wiring structure as set forth in claim 12, wherein width of the slit gradually increases in a direction toward the open end thereof in the guide portion.

14. The lead wiring structure as set forth in claim 12, wherein the guide portion is formed by deleting a part of the wall portion, and the part being located in vicinity of the open end.

15. The lead wiring structure as set forth in claim 8, wherein a spaced distance between the first penetrating portion and the second penetrating portion increases in a direction from the first face to the second face.

16. The lead wiring structure as set forth in claim 8, wherein a retaining portion is formed on the second face of the wall portion so as to engage the lead to prevent the leads from being released from the first and the second penetrating portions.

17. The lead wiring structure as set forth in claim 16, wherein the retaining portion is erected from the second face; and
wherein the retaining portion is shaped by being bent or curved in such a way as to halfway of the retaining portion become nearly parallel to the wall portion.

18. The lead wiring structure as set forth in claim 16, wherein the retaining portion is a plurality of retaining portions; and
wherein the retaining portions are placed so that ends of adjacent ones of the retaining portions are directed in substantially opposite direction.

19. The lead wiring structure as set forth in claim 16, wherein the retaining portion is provided between the first penetrating portion and the second penetrating portion.

20. The lead wiring structure as set forth in claim 16, wherein the retaining portion is integrally formed with the wall portion.

21. The lead wiring structure as set forth in claim 8, wherein a retaining portion is formed on the second face of the wall portion so as to engage the lead to prevent the leads from being released from the first penetrating portion.

22. The lead wiring structure as set forth in claim 21, wherein the retaining portion is erected from the second face;
wherein the retaining portion is shaped by being bent or curved in such a way as to halfway of the retaining portion become nearly parallel to the wall portion.

23. The lead wiring structure as set forth in claim 21, wherein the retaining portion is integrally formed with the wall portion.

24. A disk device, comprising:
a motor;
a main circuit board; and
a chassis, on which the motor and the main circuit board is mounted,
wherein a side wall of the chassis has a first face and a second face, and having a penetrating portion which penetrate from the first face to the second face and through which a motor lead is passed,
wherein the motor lead connects a terminal of the motor to a terminal of the main circuit board;
wherein the penetrating portion has a third face and a fourth face which are opposite to each other via a pass of the motor lead;
wherein the first face forms an acute angle with the third face; and
wherein the second face forms an acute angle with the fourth face.
